(19) United States
(12) Patent Application Publication
(10) Pub. No.: US 2017/0106387 A1
(43) Pub. Date: Apr. 20, 2017

(54) PISTON HAVING AN INDICIUM

(71) Applicant: The Procter & Gamble Company, Cincinnati, OH (US)

(72) Inventors: Pui San LAI, Beijing (CN); Jin ZHAN, Beijing (CN); Saumya BAREJA, Singapore (SG); Charles John BERG, JR., Wyoming, OH (US)

(21) Appl. No.: 14/882,588

(22) Filed: Oct. 14, 2015

(51) Int. Cl. B05B 11/00; G01F 23/00; A45D 40/00

(52) U.S. Cl. CPC B05B 11/0048; A45D 40/00; B05B 11/3052; G01F 23/0007; A45D 2200/051; A45D 2200/055

(57) ABSTRACT

A dispensing article having a piston with indicium provides messaging to users.

### FIELD OF THE INVENTION

The present invention is directed to articles having a piston for dispensing a contained dispensable composition.

### BACKGROUND OF THE INVENTION

Articles having a piston to dispense compositions are known. Examples include those articles containing skin care compositions (e.g., moisturizers). However, one problem associated with these articles is indicating to the user when the article is nearing its end of product life. In some executions, the user only knows of having achieved the end of product life when the piston no longer actuates (i.e., having abutted to the end of the piston's axial path) or the composition fails to dispense. This may place the user in an unpleasant or inconvenient position of obtaining a replacement or refill article in short timing or going without the product until a replacement article can be obtained.

Solutions for signaling end product of life have been described. However, many of these solutions suffer from drawbacks. This includes complicated or expensive designs. Other solutions that provide simple windows to allow user to view the remaining contained composition within the article sacrifice labeling space that could otherwise provide the user valuable information about the brand or product. Some of these windows allow too much light to shine into the container and may prematurely degrade the contained composition. Some solutions offer windows in the bottom side (i.e., underside) of the article which requires the user to remember to tilt the product and look periodically. Further, being able to view how much of the contained composition is left by looking through the bottom side can prove challenging (depending upon the type of composition or dimensions of the article). Yet further, this may require a behavior change by many users thereby placing yet a further hurdle for users to fully take advantage of this approach. Yet other solutions require the use of strings or double walls thereby requiring complicated manufacturing processes and/or increase the probability of product failure given this complexity. Temperature sensitive inks are reported, however, such an approach may not reflect variables such as environmental climate and differences in the peripheral temperatures (e.g., finger tips) among users. Furthermore, such solutions also may require user behavior changes to fully adopt such a solution. Even small windows, regardless of placement, may fail to provide enough contrast between the contained composition and the interior of the container for a user to easily tell how much composition remains in the article for the user to assess end of product life. Furthermore, these windows fail to provide the user with an element of surprise or gaming opportunity. It is well known that it is important for a brand to emotionally connect with users. There is a need to bring fun and excitement to otherwise routine operations such as dispensing compositions or signaling the end of a product life cycle. There is a need to do so that is relatively simple, inexpensive, and reliable. It is one advantage for the solution not to change the behavior of users to adopt the solution.

### SUMMARY OF THE INVENTION

The present invention attempts to address on or more of these needs. One aspect of the invention provides a piston having a circumferential outer surface having at least one indicium thereon. Another aspect of the invention provides for a dispensing article comprising: (a) an outlet nozzle; (b) a container configured to contain a dispensable composition, wherein the outlet nozzle is in fluid communication with the dispensable composition contained in the container; and (c) a piston configured to move axially within the container, and wherein the piston has a circumferential outer surface having at least a first indicium thereon. Yet another aspect of the invention provides for a personal care dispensing article comprising: (a) an outlet nozzle; (b) a container containing a dispensable composition, wherein the outlet nozzle is in fluid communication with the dispensable personal care composition contained in the container; (c) a piston configured to move axially within the container, and wherein the piston has a circumferential outer surface having at least first indicium thereon, wherein the first indicium is optionally printed thereon; (d) an airless pump configured to create a vacuum when actuated by the user as to: move the piston axially in the container, and draw the contained dispensable composition through the outlet nozzle thereby dispensing the dispensable composition; and wherein the container comprises at least a first window configured so that the at least first indicium is capable of being viewable through the first window.

### BRIEF DESCRIPTION OF THE DRAWINGS

FIG. 1 is a perspective view of a piston having indicia.

FIG. 2 is a front view of a container having a piston having first and second indicia that is visible through first and second windows, respectively.

FIG. 3 is an exploded perspective view of an article of the present invention having a piston having indicia axially moveable by a pump.

### DETAILED DESCRIPTION OF THE INVENTION

### Piston Having Indicium

One aspect of the invention provides for a piston having a circumferential outer surface having an indicium. The indicium may be in the form of text, graphic, or combination thereof. In turn, the text may in the form, for example, of a question or answer or website address or the like. Alternatively, the text may be in the form of a code (e.g., alphanumeric) as in a lottery or game (e.g., wherein the user may enter the code into a website to see if a prize is won). The graphic may be in the form of branding. Another example of a graphic may be a barcode or QR code that is scan-able (e.g., via a smart phone) to provide information to the user or provide the user an opportunity to purchase a replacement article or related article. Such an embodiment is particularly useful near the end of the product life of the article. This way, the user will not have to remember to place the article on a shopping list or risk going without a replacement/refill. Another example of a graphic is an iridescent pattern or effect (with or without text or other graphics). A game or lottery will keep the article or article's branding top of mind for the user (regardless of when the indicium is shown during the product life cycle of the article). The indicium may include information about how many more uses or amount of contained composition the article has before the end of the product life. The indicium may be in the form of a coupon or otherwise providing a discount or financial incentive to purchase another article. The phrase “near the end of the product life” means the article is almost empty or deplete of dispensable composition and that only a minority of the total volume or total weight of the contained dispensable composition remains in the article. In one embodiment this minority amount is from 1% to 25%, or 5% to 20%, or 2% to 10%, or combinations thereof of the total amount (either by volume or by weight) of contained dispensable composition remains in the article relative to the beginning of the product life cycle, i.e., when the article is “full” or brand new.

In one embodiment, more than one indicium, i.e., indicia, are provided. The indicia or indicium is provided on the circumferential outer surface of the piston. The piston is configured to move axially in a container. The container contains a dispensable composition. The piston moves axially when the contained dispensable composition is dispensed. The circumferential outer surface is configured to face an inside surface of a container. So long as the material of the container (or the relevant portion thereof) is made from a transparent or translucent material, the circumferential outer surface is visible to the user (assuming there is not a label or some other means of obscuring the view). In operation, at least a portion of the circumferential outer surface of the piston makes circumferential contact with the inside surface of the container to provide a seal such that the contained dispensable composition does not undesirably leak from the container (particularly during dispensing when there is negative or positive pressure). In one embodiment, but for the indicium, the piston has radial symmetry meaning that the piston has symmetry around a longitudinal axis.

The indicium may be provided on the piston by being printed, stickered, molded, embossing, nanoimprinting, or combinations thereof. The indicium may have color(s) or be simply be black and/or white, or may have a combination thereof. Indicia may be provided on the circumferential outer surface. For example, two, three, four or more indicium may be provided. In one embodiment, each indicium, of a multiple indicia execution, may be spatially separated from one another. This spatial separation may or may not be equidistant between the indicium. Any one indicium may occupy from 0.01% to 100%, alternatively from 0.1% to 99%, or from 1% to 5%, or from 2% to 10%, or from 0.1% to 10%, or combinations thereof of the total surface area of the circumferential outer surface (of the piston). In one embodiment, the surface area occupied of an indicium is from 10 mm² to 500 mm², alternatively from 100 mm² to 400 mm², or from 200 mm² to 500 mm², or from 50 mm² to 300 mm², or from 200 mm² to 300 mm², or combination thereof.

In one embodiment, a single indicium is repeated around the entire circumference of the circumferential outer surface such that the manufacturer need not be concerned with aligning an indicium, or a particular aspect of the indicium, with a specific window. In other words, if aspects of the indicium are repeated, a desired aspect of the indicium may be visible through a window regardless of how the window and the piston are aligned. Alternatively, the piston and window are aligned (e.g., by way well know techniques such as optical sensing and the like) such that an indicium and its corresponding window are aligned (and accordingly the indicium will be viewable through the window at the desired moment of the article's product life (e.g., near the end of the product life)).

In a preferred embodiment, the indicium is provided such there is not protuberance, or otherwise an interference, with the operation of the piston (e.g., axial movement of the piston in the container and sealing function thereof). The piston is preferably comprised of a plastic, more preferably thermoplastic. The piston may be solid (e.g., characteristic of injected molded plastic) or the piston may contain an interior volume (e.g., characteristic of blow molding plastic). One example of a suitable plastic is polypropylene or high density polyethylene (HDPE). The indicium is preferably printed on the piston. Examples of suitable printing techniques include silk screen printing and ink jet printing.

In one embodiment, the article is a personal care article, wherein the dispensable contained composition is a personal care composition (e.g., skin moisturizer). Suitable dimensions of the piston in such an embodiment may include a diameter from 5 mm to 500 mm, or from 10 mm to 100 mm, or from 20 mm to 200 mm, or from 20 mm to 80 mm, or from 30 mm to 60 mm, or about 45 mm, or combinations thereof. The height of circumferential surface (of the piston) is from 1 mm to 75 mm, or from 3 mm to 50 mm, or from 4 mm to 25 mm or from 5 mm to 15 mm, or 6 mm to 14 mm, or about 11 mm, or combinations thereof. The height of circumferential surface is measured orthogonal to the diameter of the piston. The inner diameter of the container is about the same as the diameter of the piston. However, the piston diameter (outside of the container) may be slightly greater than that of the inner diameter of the container so as to form a seal with the inside surface of the container. In one embodiment, a ratio of a height of the circumferential outer surface to a diameter of the piston is from 1:8 to 3:8, or about 1:4, respectively. The piston is configured to be receivable in the container and capable of forming a seal circumferentially around the inside surface of the container. Preferably the piston has a circular cross section (relative to a longitudinal axis).

### Container

The container of the present invention is configured to contain a dispensable composition or may contain the dispensable composition. The container is preferably a cylindrical container (i.e., having a circular cross section relative to a longitudinal axis), wherein the container has an interior volume that contains the dispensable composition. Alternatively, the container may be oval or oblong or the like (and wherein the piston has the same corresponding shape). The piston is configured to move axially in the container (when the dispensable composition is dispensed from the article). The piston can move axially “up” or “down” relative to the outlet nozzle of the article. The container may be configured to contain from 10 ml to 2 liters, or from 15 ml to 1,000 ml, or from 25 ml to 300 ml, or from 50 ml to 200 ml, or from 75 ml to 150 ml, or combinations thereof of the dispensable composition. In one embodiment, the container has a height from 1 cm to 20 cm, or from 2 cm to 15 cm, or from 3 cm to 10 cm, or from 4 cm to 7 cm, or from 2 cm or 8 cm, or from 4 cm to 6 cm, or combinations thereof. The dispensable composition may be a personal care composition. Non-limiting examples may include hair care, skin care, shave care, fabric care, air care, soft surface care, hard surface care, dish care, or health care. One non-limiting example is a skin moisturizing composition from OLAY® brand of moisturizers. The container is preferably comprised of a plastic. One non-limiting example of such plastic may include polypropylene (PP). Preferably the material the container is made from is transparent or translucent so that the circumferential outer surface of the piston (and indicia) are visible there through. In one embodiment, the bottom of the container has an air hole to maintain atmospheric pressure, i.e., avoid any undesirable pressure changes that may be created during dispensing of the dispensable composition from the article. This way, the piston is free to move axially within the interior volume of the container without resistance that may be otherwise undesirably created by pressure attributable to the moving piston and the area of the container that is not containing the dispensable composition.

The term “outlet nozzle” is used herein the broadest sense to include any product dispensing port or orifice suitable for the contained product to exit the article.

### Window

The article of the present invention comprises a window so that the indicium (of the circumferential outer surface) is visible to the user. This visibility of the indicium need not be visible to the user during the entire product life cycle of the article (i.e., when the article is full as well as empty). Rather, the window may be positioned so that the indicium is only visible at certain point(s) of the article's product life. This way, messaging may be strategically provided to the user when it is most relevant. For example, the user may be reminded to replace the article only at the relevant time, i.e., near the end of the article's product life. In contrast, the user will typically not find this kind of information relevant when the article is full (since there is plenty of composition yet to dispense) or at the end of the product life (i.e., when the article is empty or devoid of any dispensable composition).

Although it is preferred that container is made from a plastic, or a material that is clear or translucent, the use of labeling may be used to selectively position and/or define a window. The labeling may be in the form of a sticker, or printing, or shrink sleeve that is applied or affixed to a surface, preferably outer surface, of the container. The labeling may also contain product related information (branding, usage instructions, and the like).

Alternatively dye, ink, pigment, or the like may be selectively used, with the material used to make the container, or applied directly to the container to define the window. In other words, the dye, ink, and pigment may be used to selectively obfuscate the indicia from view (unless it is a defined window).

More than one window may be used. More than one indicium (of the outer circumferential surface of the piston) may be used. A single window may be configured for a single indicium (and a single indicium may be configured for a single window), or a single window may be configured for two or more indicia. Alternatively, a single indicium may be configured so that it is visible through two or more windows. Any one window may be configured so that it is from 0.01% to 99%, or alternatively from 0.1% to 50%, or from 1% to 5%, or from 2% to 10%, or from 0.1% to 10%, or combinations thereof of the total surface area of the outer surface of the container. In one embodiment, the outer surface of the container comprises a non-window such that the indicium (of the piston) is not visible to a user for at least one position of the article's product life. In one embodiment, the window occupies a surface area from 10 mm² to 500 mm², alternatively from 50 mm² to 400 mm², or 100 mm² to 300 mm², or 10 mm² to 200 mm², or 300 mm² to 500 mm², or 200 mm² to 400 mm², or combination thereof.

Window(s) may be of different shapes and sizes. In one embodiment, the window, or a window aspect, is in the shape of a polygon, preferably a regular polygon. Non-limiting examples of a polygon include square, rectangle, triangle, parallelogram, and the like. Other window shapes, or window aspects, may include circles, ovals, curved or arched aspects, and the like. Windows may have graduating shapes (e.g., narrowing or broadening in area along the window length). Relative to a longitudinal axis of the article, the length of the window (i.e., longest dimension) may be in a plane that is orthogonal to the longitudinal axis (i.e., a “horizontal” window). Alternatively, the length of the window may be in plane that is parallel to the longitudinal axis (i.e., a “vertical” window). Alternatively still, the length of the window may be in a diagonal plane relative to the longitudinal axis (e.g., a “spiraling” window). The angle formed by diagonal window, relative to the longitudinal axis, may be from 1 degree to 89 degrees, or from 10 degrees to 80 degrees, or from 30 degrees to 60 degrees, or from 35 degrees to 55 degrees, or about 45 degrees, or combinations thereof. In one embodiment, the diagonal window has an angular measurement (relative to the longitudinal axis) from 1 radian to 10 radians, or from 2 radians to 6 radians, or from 0.1 radians to 3 radians, or from 1 radian to 4 radians, or from 0.5 radian to 2 radians, or combinations thereof. The piston indicium, relative to the longitudinal axis, may have an angular measurement corresponding to that of the window. The angular measurement of the indicium may be slightly larger than the window angular measurement to provide greater alignment tolerance. Of course, the diagonal window may be a single window or may be separated into two or more windows. One advantage of such a diagonal window is that the user has a rotating view of the piston (specifically the circumferential outer surface) as the piston axially moves during the product cycle, thereby allowing a different portion of the indicium to be exposed and visible to the user (allowing for dynamic messaging). The piston would ordinarily not move rotationally (around the longitudinal axis), but rather only move axially (along the longitudinal axis) in the container during dispensable composition dispensing. The indicium, in this diagonal window embodiment, can be designed to take advantage of this spatial relationship. For example, the indicium (or indicia) of the piston could be one having changing colors starting from green, transitioning to yellow, and finishing with red. These changes in color could symbolize to a user the amount of contained dispensable composition during the product cycle. A first portion of the indicium (or a first indicium) would be only visible to the user through the diagonal window in the beginning of the product cycle (e.g., green color). Second portion of the indicium (or a second indicium) would be only visible to the user through the diagonal window in about the middle of the product cycle (e.g., yellow color). Lastly, a third portion of the indicium (or a third indicium) would be only visible to the user at the end, or near the end, of the produce cycle (e.g., red color). One variation is the use of a single indicium that changes colors along the angular measurement. For example, the color change may include green transitioning to light green, to yellow, to orange, and then finishing with red. Such a color changing indicium could be viewed through a single diagonal window. Of course a plurality of indicia may be used, each spatially separated from one another, with each indicium having its own unique color. In another example, one more colors of the indicium (or indicia) may vary in hue, chroma, saturation, purity, intensity, and the like, along the angular measurement (i.e., as the indicium becomes visible during the product life of the article).

In another embodiment, three different indicia may be used, wherein each indicia corresponds to a unique window (for a total of three respective windows). Each indicium is spatially separated on the circumferential outer surface of the piston. Each window is spatially separated on the cylinder, preferably both radially and axially. The windows may be rectangular horizontal windows (or any other shape). The indicia may be used to indicate to the user how many doses are left during the product life of the article. The article may have a total of 50 doses of dispensable composition contained therein. Half way through the product life, wherein the piston has traveled axially about 50% of its path, a first indicium comes into view through a first window. The first indicium may be text that states to the user, “Half way through” or words to the effect that the product is half through its product life. A second indicium may come into view through a second window about 75% of the article product life and axial path of the piston. The second indicium may have text that states to the user, “Only ¼ left” or “Less than 15 uses left” or similar words to this effect. A third and final indicium may come into view through a third window about 90% of the article product life and axial path of the piston. The third indicium may have text that states to the user, “Less than 5 uses left” or “Order your refill” or similar words to this effect. One advantage of such a multi-indicia and multi-window approach is that plenty of notice is provided to the user so the user has multiple reminders and opportunities to replace the article and not risk going without the product.

In one embodiment the first window and second window each have the same comparable surface area. In a second embodiment, the first window and second window each have a different comparable surface area.

In yet another embodiment, labeling of the article may used to compliment the indicium (or indicia), particularly in the area immediately adjacent, surrounding, and/or defining the window. For example, a first indicium may indicate that the article is half-way through the product cycle and the label provides a defined area for the user to write down the date. This information can be used to help predict when the product may expire based upon the user's product usage habits.

### Pump

The article preferably comprises a pump as means to dispense the dispensable composition contained in the article by way of creating a vacuum (negative pressure) or increased pressure (positive pressure). The force necessary to actuate the pump may come from the user (e.g., by pressing or pulling on the article) or by releasing compressed gas (e.g., Nitrogen). The piston moves axially in the container while the contained dispensable composition is dispensed. The article may or may not contain a piston rod functionally attached to the piston. In a preferred embodiment, the article is free of a piston rod. The pump may exert positive pressure or negative pressure to dispense the dispensable composition. One non-limiting example of a pump is an airless pump branded as PEARL Airless Dispensing System, manufactured by MWV, Richmond, Va., USA that creates negative pressure when the user presses down on the pump.

In one embodiment, the article may comprise two or more pistons, wherein each piston is associated with its own unique window(s). For example, an article may comprise a first container and a second container, wherein a first piston is configured to move axially within the first container, and the second piston is configured to move axially within the second container. The first piston has a first circumferential outer surface having at least a first indicium, and wherein the second piston has a second circumferential outer surface having at least a second indicium. The first indicium is viewable through a first window on the first container. The second indicium is viewable through a second window on the second container. The containers/pistons may be opposing each other or may be in tandem. The article may have a single outlet nozzle wherein the first piston is associated with a first dispensable composition (contained in the first container) and the second piston is associated with a second dispensable composition (contained in the second container), wherein the first and second dispensable compositions are combined within the article before exiting through a single outlet nozzle. Alternatively, the article contains a first outlet nozzle and second outlet nozzle, wherein the first outlet nozzle is associated with the first dispensable composition/first container/first piston (i.e., in fluid communication), while the second outlet nozzle is associated with the second dispensable composition/second container/second piston (i.e., in fluid communication), wherein the first and second composition may or may not be mixed outside of the article (when dispensed from the article). Such multi-piston and multi-compositional articles may be useful when the contained compositions are incompatible with each other or are chemically reactive with each other. Different or the same volumes of the first and second compositions may be contained/dispensed by the article.

### EXAMPLE

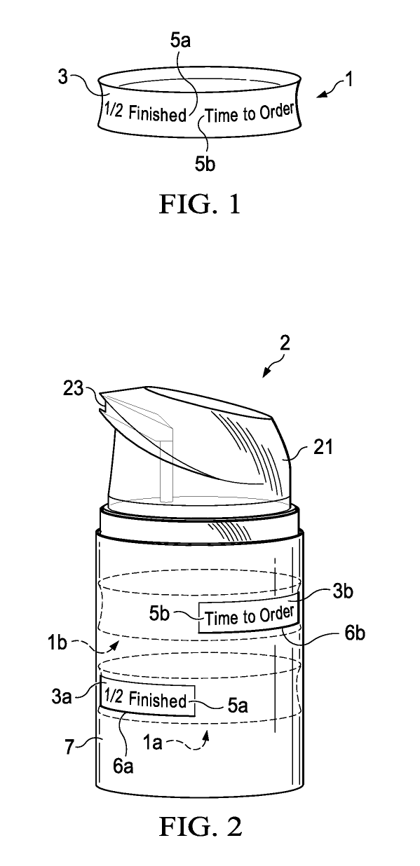

FIG. 1 is a non-limiting example of a piston (1) of the present invention. The piston (1) is cylindrically shaped. The piston (1) has a circumferential outer surface (3) having a first and second indicia (5a, 5b). A first indicium (5a) is the form of text states: “½ Finished.” A second indicium (5b) is the form text that states: “Time to Order.” Although not show, an ordering website may be provided (e.g., “www.pg.com”). The circumferential outer surface (3) need not be planar, but rather can be concave. Without wishing to be bound by theory, the concave shape may allow for a good balance of seal-ability and minimizing undesirable frictional resistance, but yet also provides a relatively large surface area to provide the indicia (5a, 5b) so that the indicia can be of sufficient size to be easily read or viewed by the user. This is particularly useful in relatively small volume articles (e.g., less than 200 ml volume of contained dispensable composition). The concave surface may also provide an advantage of not having the indicium rub off when the piston moves.

FIG. 2 is a front view of a portion of an article (2) of the present invention notably having first and second windows (6a, 6b) from which first and second indicia (5a, 5b) may be viewed there through, respectively. The container (7) contains a dispensable personal care composition (not shown). The circumferential outer surface (3) of the piston (1) is configured to face the inner surface of the container (7). The piston (1) is configured to move axially in the container (7) when the dispensable personal care composition is dispensed from the article (2). There are two positions of a single piston (1) shown in FIG. 2 (relative to the product life of the article (2)). In a first position, the piston (1a) has moved halfway through its axial path consistent with the product life of the article (2). In a second position, the piston (1b) is near the end of the product life of the article (2). The container (7) has a label (not shown) in the form of a shrink sleeve affixed to the outer surface of the container (7). The container (7) is made from a plastic that is otherwise clear or translucent (but for the shrink sleeve). The shrink sleeve has graphics and the like so there are two defined windows (6a, 6b), i.e., defined areas that are free of graphics and the like, so that inside of the container (7) is otherwise viewable to the user. At about the halfway point of the product life of the article, the piston (1a) is positioned about halfway through its axial path, the first indicium (5a) on the circumferential outer surface (3a) appears into view of the user through the first window (6a). An important message is provided to the user. The first indicia (5a) indicates that the article is “½ Finished” with its product life thereby suggesting to the user to begin making initial preparations to replenish the article (2). Roughly at 75% of the product life of the article (2) (i.e., about 25% of the remaining volume of the contained dispensable composition (not shown) is remaining), and thus about 75% of the piston's (1) axial path through the container (7) completed, the second indicium (5b) on the circumferential outer surface (3b) through the second window (6b) becomes visible to the user. A second important message is provided to the user. The second indicia (5b) indicates the article (2) is almost empty and that it is “Time to Order” (a replacement article (2)) to ensure that the user is not subjected to an empty article (2). Both the indicia (5a, 5b) and the windows (6a, 6b) are spatially and radially offset.

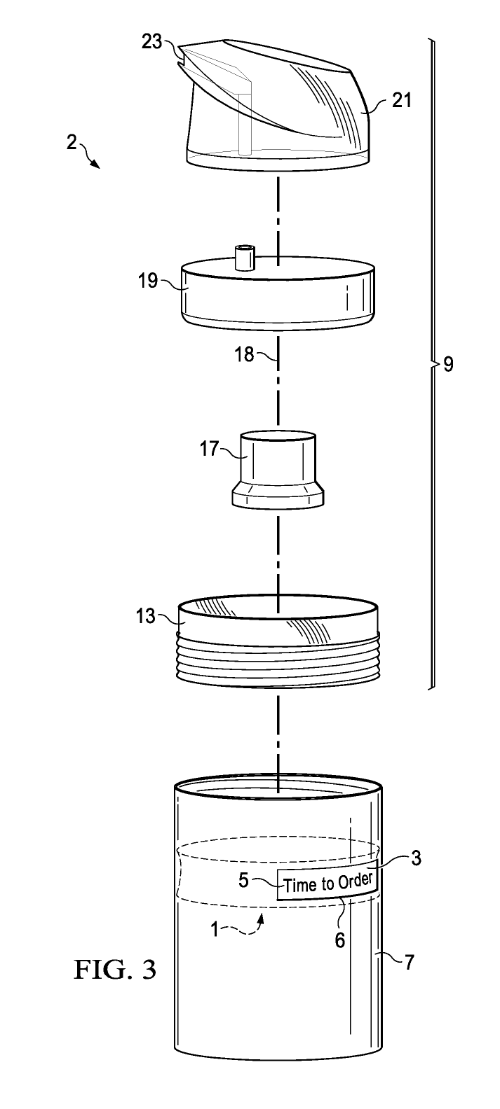

FIG. 3 is an exploded perspective view of a non-limiting example of article (2) of the present invention. The container (7), piston (1), and pump (9) are assembled together to form the article (2). The pump (9), in turn, is comprised of a base (13) that fits into the top of the container (7) and remains fixed—even during a pumping/dispensing operation. A silicone bellow (17) is between the base (13) and a header (19). The header (19) functions to channel contained dispensable composition from the container to the outlet nozzle and provides an opposing side for the silicone bellow (17) (opposite the base (13)). The header (19) is received inside a hood (21). The hood (21) contains an outlet nozzle (23) from which the dispensable composition (not shown) contained in the container (7) is dispensed. The outlet nozzle (23) is in fluid communication with the dispensable composition contained in the container (7). The user pushes down on the hood (21) to actuate the pump (9). The dispensable composition exits the article, via the outlet nozzle (23), from the negative pressure that is created by the pump (9) (when the user releases from pushing down on the hood (21)). The piston (1) axially moves in the container (7) along a longitudinal axis (18) toward the pump (9), during the pumping operation (i.e., while the contained dispensable composition is dispensed). The pump (9) is an airless one. About 0.1 ml to 5 ml of dispensed composition is dispensed during a single dispensing actuation (alternatively from 1 ml to 4 ml, or 2 ml to 5 ml, or 0.5 ml to 3 ml, or combinations thereof). An indicium (5), on the circumferential outer surface (3) of the piston (1), is viewable through a window (6) on the container (7). Diameters of the container (7) and piston (1) are taken orthogonal to the longitudinal axis (18). The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A piston (1) having a circumferential outer surface (3) having at least one indicium (5) thereon.

2. The piston (1) of claim 1, wherein the indicium (5) is selected from text, graphic, or combination thereof.

3. The piston (1) of claim 2, wherein the indicium (5) is printed to the circumferential outer surface (3).

4. The piston (1) of claim 1, wherein a ratio of a height of the circumferential outer surface (3) to a diameter of the piston (1) is from 1:8 to 3:8, respectively.

5. The piston (1) of claim 1, further comprising a second indicium (5b), wherein the first indicium (5a) and second indicium (5b) are preferably spatially separated.

6. The piston (1) of claim 1, wherein the piston (1) is a plastic, and except for the indicium (5) is radially symmetrical.

7. A dispensing article (2) comprising:
(a) an outlet nozzle (23);
(b) a container (7) configured to contain a dispensable composition, wherein the outlet nozzle (23) is in fluid communication with the dispensable composition contained in the container (7); and
(c) a piston (1) configured to move axially within the container (7), and wherein the piston (1) has a circumferential outer surface (3) having at least a first indicium (5a) thereon.

8. The article (2) of claim 7, wherein the container (7) comprises at least a first window (6a) configured so that the at least first indicium (5a) is capable of being viewable there through.

9. The article (2) of claim 8, wherein the circumferential outer surface (3) further comprises a second indicium (5b), wherein the container (7) further comprises a second window (6b), wherein the first indicium (5a) is capable of being viewable only through the first window (6a) and wherein the second indicium (5b) is capable of being viewable only through the second window (6b).

10. The article (2) of claim 9, wherein the first window (6a) and the second window (6b) are spatially separate, and wherein the spatial separation is both radial and axial.

11. The article (2) of claim 8, wherein the least first window (6a) is configured so that the least first indicium (5a) is viewable near the end of product life of the article (2), but is not viewable at the beginning of the product life of the article (2).

12. The article (2) of claim 10, wherein either the first window (6a) or the second window (6b) is configured so that the respective first indicium (5a) or second indicium (5b) is viewable near the end of product life of the article (2).

13. The article (2) of claim 10, wherein the circumferential outer surface (3) further comprises a third indicium (5) spatially separated from the first indicium (5a) and second indicium (5b), wherein the container (7) further comprises a third window (6), wherein the third indicium (5) is viewable only through the third window (6).

14. The article (2) of claim 8, wherein the article (2) further comprises a shrink sleeve over an outer surface of the container (7) wherein the first window (6a) portion of the shrink sleeve is clear or translucent.

15. The article (2) of claim 7, further comprising a pump (9) configured to create a vacuum when actuated by the user as to move the piston axially in the container (7) and draw the contained dispensable composition through the outlet nozzle (23) thereby dispensing the dispensable composition.

16. The article (2) of claim 7, wherein the piston (1) comprises a height of the circumferential outer surface (3) and a piston diameter, wherein the height to the diameter is from 1:8 to 3:8, respectively.

17. The article (2) of claim 7, wherein the at least a first window (6a) is a diagonal window, and wherein the diagonal window has angular measurement from 0.5 radian to 10 radians.

18. A personal care dispensing article (2) comprising:
(a) an outlet nozzle (23);
(b) a container (7) containing a dispensable composition, wherein the outlet nozzle (23) is in fluid communication with the dispensable personal care composition contained in the container (7);
(c) a piston (1) configured to move axially within the container (7), and wherein the piston (1) has a circumferential outer surface (3) having at least first indicium (5a) thereon, wherein the first indicium (5a) is printed thereon;
(d) an airless pump (9) configured to create vacuum when actuated by the user as to move the piston axially in the container (7) and draw the contained dispensable composition through the outlet nozzle (23) thereby dispensing the dispensable composition; and
wherein the container (7) comprises at least a first window (6a) configured so that the at least first indicium (5a) is capable of being viewable there through.
